(19) United States
(12) Patent Application Publication
(10) Pub. No.: US 2014/0377078 A1
(43) Pub. Date: Dec. 25, 2014

(54) ROOT STIFFENER FOR A WIND TURBINE ROTOR BLADE

(71) Applicant: General Electric Company, Schenectady, NY (US)

(72) Inventors: Bharat Bagepalli, Niskyuna, NY (US); Bradley Graham Moore, Greenville, SC (US); Neils Christian Schmitt, Clifton Park, NY (US)

(21) Appl. No.: 13/924,910

(22) Filed: Jun. 24, 2013

(51) Int. Cl. F03D 1/06

(52) U.S. Cl. CPC F03D 1/0675
USPC 416/241 R

(57) ABSTRACT

A rotor blade for a wind turbine may include a body extending between a root end and a tip end. The body may include a root portion extending from the root end. The root portion may include an inner surface defining an inner circumference. The rotor blade may also include a root stiffener disposed within the root portion of the body. The root stiffener may be substantially ring-shaped and may extend around the inner circumference of the root portion. The root stiffener may define a plurality of radially oriented openings configured to receive fasteners for coupling the root stiffener to the root portion.

### FIELD OF THE INVENTION

The present subject matter relates generally to wind turbines and, more particularly, to a root stiffener for stiffening the root portion of a wind turbine rotor blade.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known airfoil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

To ensure that wind power remains a viable energy source, efforts have been made to increase energy outputs by modifying the size and capacity of wind turbines. One such modification has been to increase the length of the rotor blades. However, as is generally understood, the loading on a rotor blade is a function of blade length, along with wind speed and turbine operating states. Thus, longer rotor blades may be subject to increased loading, particularly when a wind turbine is operating in high-speed wind conditions.

During the operation of a wind turbine, the loads acting on a rotor blade are transmitted through the blade and into the blade root or root portion of the blade. Thus, as rotor blades are lengthened and the loads acting on such blades increase, there is an increased likelihood that the resulting loads may cause ovalization or out-of-roundness of the root portion. Such ovalization of the root portion may result in an increase in the magnitude of the loads that are transmitted through the root portion and into the pitch bearing and hub of the wind turbine, which may, in turn, increase the likelihood of damage occurring to the hub and/or various other components of the wind turbine (e.g., the main rotor shaft of the wind turbine turbine).

Accordingly, a root stiffener that may be used to reduce the occurrence and/or amount of ovalization within the root portion of a rotor blade would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a rotor blade for a wind turbine. The rotor blade may include a body extending between a root end and a tip end. The body may include a root portion extending from the root end. The root portion may include an inner surface defining an inner circumference. The rotor blade may also include a root stiffener disposed within the root portion of the body. The root stiffener may be substantially ring-shaped and may extend around the inner circumference of the root portion. The root stiffener may define a plurality of radially oriented openings configured to receive fasteners for coupling the root stiffener to the root portion.

In another aspect, the present subject matter is directed to a rotor blade for a wind turbine. The rotor blade may include a body extending between a root end and a tip end. The body may include a root portion extending from the root end. The root portion may include an outer surface defining an outer circumference. In addition, the rotor blade may include a root stiffener coupled to the root portion. The root stiffener may extend at least partially around the outer circumference of the root portion.

In a further aspect, the present subject matter is directed to a rotor blade for a wind turbine. The rotor blade may include a body extending between a root end and a tip end. The body may include a root portion extending from the root end. The root portion may define a ring-shaped trench at the root end. In addition, the rotor bade may include a rigid root stiffener received within the trench. The root stiffener may be substantially ring-shaped.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine;

FIG. 2 illustrates a perspective view of one embodiment of one of the rotor blades of the wind turbine shown in FIG. 1;

FIG. 3 illustrates a perspective view of one embodiment of a root stiffener installed within a rotor blade of a wind turbine in accordance with aspects of the present subject matter, particularly illustrating a portion of the rotor blade being cut-away in order to expose the root stiffener;

FIG. 4 illustrates a top view of the root stiffener shown in FIG. 3, particularly illustrating cross-braces being installed onto the root stiffener;

FIG. 5 illustrates a partial, cross-sectional view of the root stiffener shown in FIG. 4 taken about line 5-5;

FIG. 6 illustrates a partial, cross-sectional view of another embodiment of the root stiffener shown in FIG. 4, particularly illustrating the root stiffener being coupled to a barrel nut mounted within the rotor blade;

FIG. 7 illustrates a perspective view of one embodiment of a root stiffener formed from a single stiffener segment in accordance with aspects of the present subject matter;

FIG. 8 illustrates a perspective view of one embodiment of a root stiffener formed from a plurality of stiffener segments in accordance with aspects of the present subject matter;

FIG. 9 illustrates a partial, perspective view of the root stiffeners shown in FIGS. 7 and 8, particularly illustrating a connection joint that may be suitable for use with the root stiffeners in accordance with aspects of the present subject matter;

FIG. 10 illustrates a top view of another embodiment of a connection joint that may be suitable for use with the root stiffeners shown in FIGS. 7 and 8 in accordance with aspects of the present subject matter;

FIG. 11 illustrates a partial, perspective view of another embodiment of a root stiffener in accordance with aspects of the present subject matter, particularly illustrating a portion of the root stiffener being exploded outwardly from a rotor blade of the wind turbine;

FIG. 12 illustrates a partial, perspective view of a portion of the root stiffener shown in FIG. 11 installed within the rotor blade;

FIG. 13 illustrates a perspective view of another embodiment of a root stiffener installed on a rotor blade of a wind turbine in accordance with aspects of the present subject matter;

FIG. 14 illustrates a partial, cross-sectional view of the root stiffener shown in FIG. 13 taken about line 14-14;

FIG. 15 illustrates a perspective view of another embodiment of a root stiffener embedded within a rotor blade of a wind turbine in accordance with aspects of the present subject matter;

FIG. 16 illustrates a partial cross-sectional view of the rotor blade shown in FIG. 15 taken about line 16-16, particularly illustrating the root stiffener exploded away from the rotor blade;

FIG. 17 illustrates a partial, perspective view of a rotor blade having a plurality of root stiffeners installed therein/thereon.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a root stiffener for a wind turbine rotor blade. Specifically, in several embodiments, the root stiffener may be configured to be installed within the blade root or root portion of a rotor blade in order to increase the stiffness of the root portion, thereby preventing and/or reducing the amount of ovalization occurring within the root portion. As such, the amount of loads transmitted through the root portion and into the pitch bearing and/or hub of the wind turbine may be reduced significantly. Such a reduction in transmitted loads may allow for longer rotor blades to be installed on a wind turbine, which may, in turn, increase the energy capturing capability of the wind turbine.

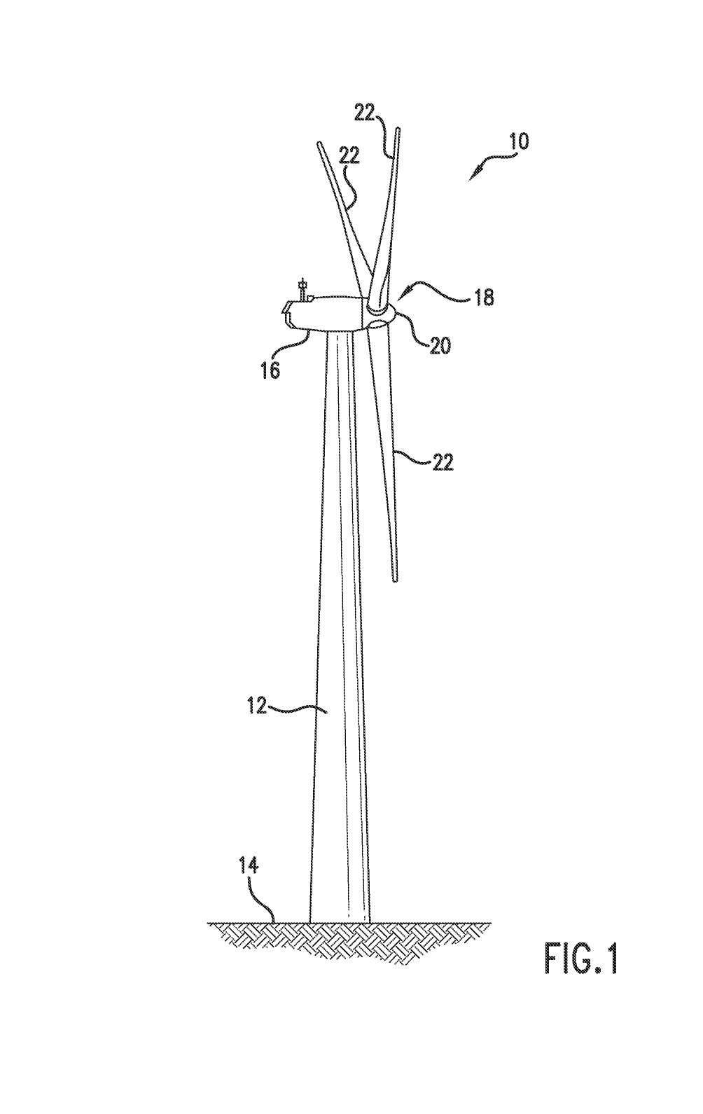

Referring now to the drawings, FIG. 1 illustrates a perspective view of one embodiment of a wind turbine 10. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator (not shown) positioned within the nacelle 16 to permit electrical energy to be produced.

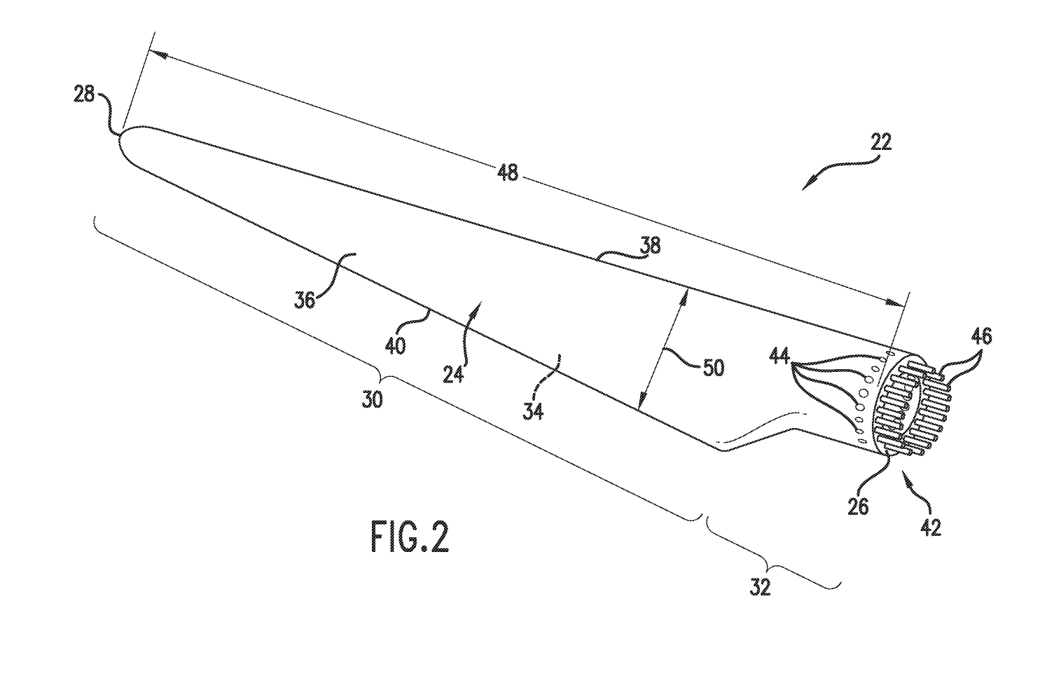

Referring now to FIG. 2, a perspective view of one of the rotor blades 22 shown FIG. 1 is illustrated in accordance with aspects of the present subject matter. As shown, the rotor blade 22 includes a body 24 extending longitudinally between a root end 26 and a tip end 28. The body 24 may generally serve as the outer shell/skin of the rotor blade 22 and may include both an airfoil portion 30 and a root portion 32. As is generally understood, the airfoil portion 30 may extend between the root portion 32 and the tip end 28 of the rotor blade 22 and may generally define an aerodynamic profile (e.g., by defining an airfoil shaped cross-section, such as a symmetrical or cambered airfoil-shaped cross-section) to enable the rotor blade 22 to capture kinetic energy from the wind using known aerodynamic principles. Thus, the airfoil portion 30 may generally include a pressure side 34 and a suction side 36 extending between a leading edge 38 and a trailing edge 40.

Additionally, the root portion 32 may generally be configured to extend between the root end 26 and the airfoil portion 30 of the rotor blade 22. As shown in FIG. 2, at least a portion of the root portion 32 may be configured to define a substantially cylindrical shape. As is generally understood, the root portion 32 may be configured to be mounted or otherwise attached to the wind turbine hub 20 at the root end 26 of the rotor blade 22. Thus, as shown in FIG. 2, the root portion 32 may include a plurality of T-bolts or root attachment assemblies 42 installed therein for coupling the rotor blade 22 to the hub 20. In several embodiments, each root attachment assembly 42 may include a barrel nut 44 mounted within the root portion 32 and a root bolt 46 coupled to and extending from the barrel nut 44 so as to project outwardly from the root end 26. By projecting outwardly from the root end 26, the root bolts 46 may be used to couple the rotor blade 22 to the hub 20 (e.g., via a pitch bearing (not shown)).

Moreover, as shown in FIG. 2, the rotor blade 22 may have a span 48 defining the total length of the blade 22 between its root and tip ends 26, 28 and a chord 50 defining the total length of the blade 22 between the leading edge 38 and the trailing edge 40. As is generally understood, the chord 50 may vary in length with respect to the span 48 as the rotor blade 22 extends from the root end 26 to the tip end 28.

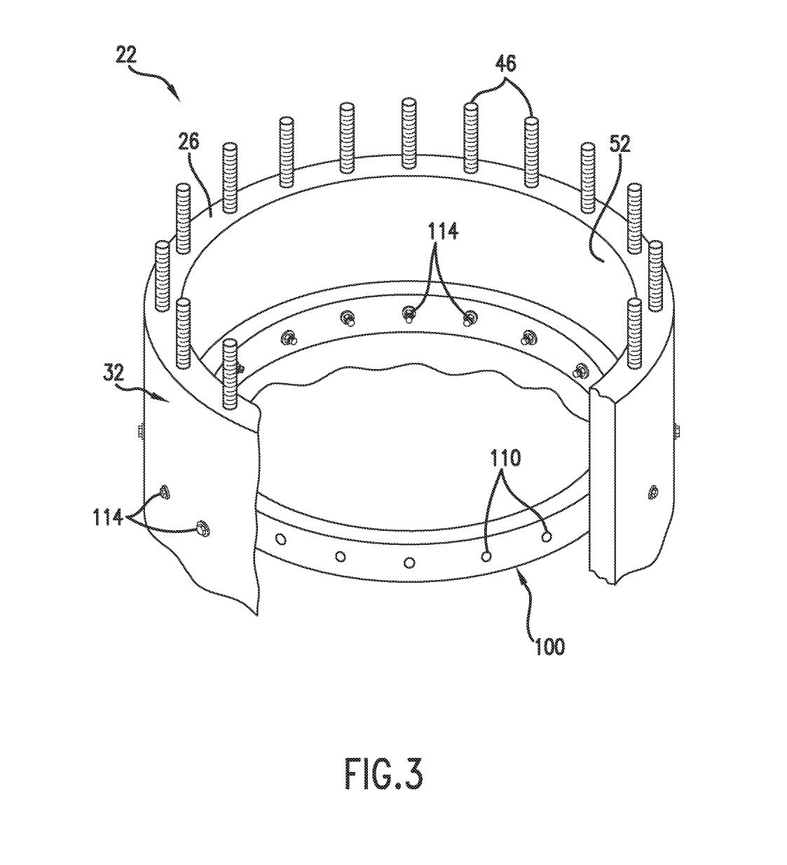

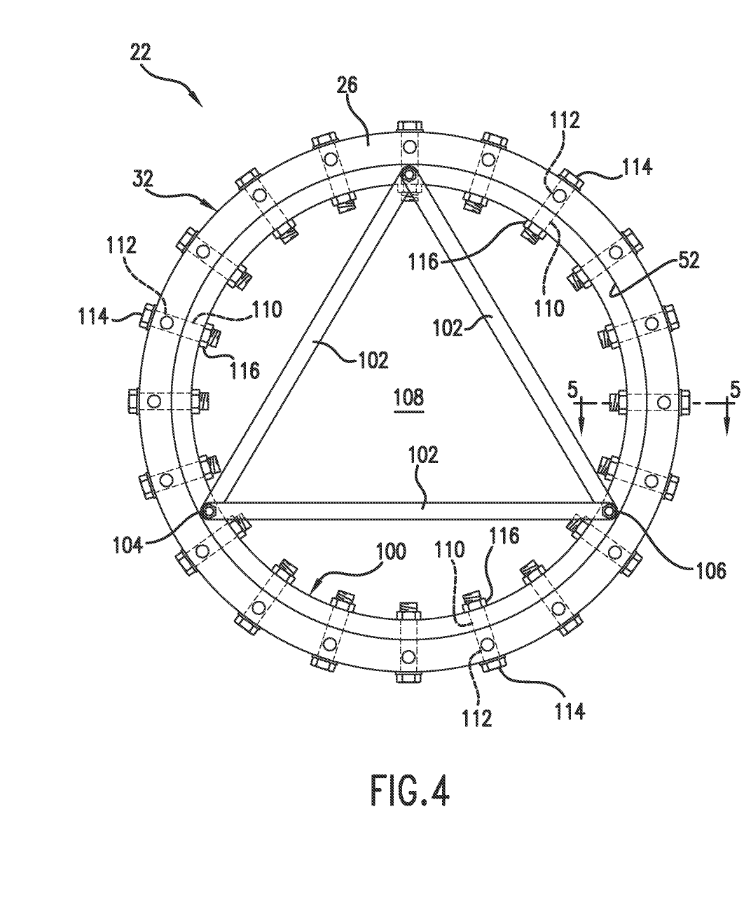

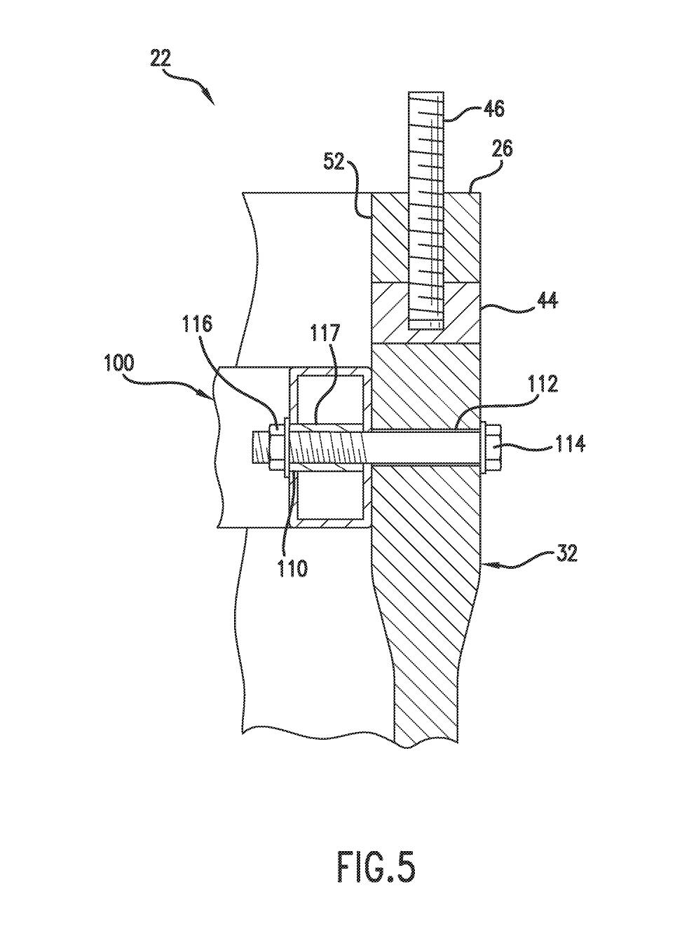

Referring now to FIGS. 3-5, one embodiment of a root stiffener 100 suitable for use with the rotor blade 22 described above is illustrated in accordance with aspects of the present subject matter. In particular, FIG. 3 illustrates a perspective view of the root stiffener 100 installed within the root portion 32 of the rotor blade 22 (with a portion of the rotor blade 22 being cut-away). FIG. 4 illustrates a top view of the root stiffener 100 shown in FIG. 3. Additionally, FIG. 5 illustrates a partial, cross-sectional view of the root stiffener 100 shown in FIG. 4 taken about line 5-5.

In general, the root stiffener 100 may be configured to be installed within the root portion 32 of the rotor blade 22. Specifically, in several embodiments, the root stiffener 100 may comprise a substantially ring-shaped stiffening member that is configured to be position adjacent to an inner surface 52 of the root portion 32 such that the stiffener 100 extends around the inner circumference of the root portion 32. As such, when installed within the rotor blade 22, the root stiffener 100 may generally increase the overall stiffness and/or rigidity of the root portion 32, thereby preventing and/or reducing the amount of ovalization within the root portion 32.

As shown in FIGS. 3-5, in several embodiments, the root stiffener 100 may be formed as a continuous, non-jointed ring. For example, the root stiffener 100 may be formed or molded into a 360 degree ring having an outer diameter that generally corresponds to the inner diameter of the root portion 32. Alternatively, as will be described below, the root stiffener 100 may be configured as a jointed ring formed from one or more stiffener segments.

Additionally, the root stiffener 100 may generally be formed from any suitable material. For instance, in several embodiments, the root stiffener 100 may be formed from a relatively stiff and rigid material, such as a suitable metal material (e.g., steel), a suitable laminate composite material (e.g., a carbon or glass fiber reinforced composite), or any other suitable stiff/rigid material. Moreover, it may also be desirable for the root stiffener 100 to be relatively lightweight. Thus, as shown in FIG. 5, the root stiffener 100 may, in one embodiment, define a hollow cross-section. However, in other embodiments, the root stiffener 100 may have a solid cross-section.

Further, in several embodiments, one or more cross-braces 102 may be configured to extend across separate portions of the root stiffener 100 to provide further stiffness to the root portion 32 of the rotor blade 22. Specifically, as shown in FIG. 4, each cross-brace 102 may be coupled to the root stiffener at two locations around its circumference (e.g., at points 104 and 106) so as to extend across an opening 108 defined by the stiffener 100. In the illustrated embodiment, three cross-braces 102 are coupled to the root stiffener 100 in a triangular pattern. However, in alternative embodiments, any other number of cross-braces 102 may be coupled to the root stiffener 100, with the cross-braces(s) 102 forming any suitable pattern,

It should be appreciated that the root stiffener 100 may generally be configured to be coupled within the root portion 32 of the rotor blade 22 using any suitable means known in the art. For example, as shown in the illustrated embodiment, the root stiffener 100 may define a plurality of radially oriented stiffener openings 110 configured to be aligned with corresponding radially oriented root openings 112 defined in the root portion 32. In such an embodiment, suitable radially extending fasteners 114 (e.g., bolts, screws, pins, threaded rods, etc.) may be inserted through the aligned openings 112, 114 defined in the root stiffener 100 and the root portion 32 and subsequently secured therein using nuts 116 (and, optionally, washers) and/or any other suitable components. Additionally, as particularly shown in FIG. 5, a stiffening member 117 may be inserted within the openings 110 defined in the root stiffener 100 to provide additional structure/support at the each attachments point between the stiffener 100 and the rotor blade 22.

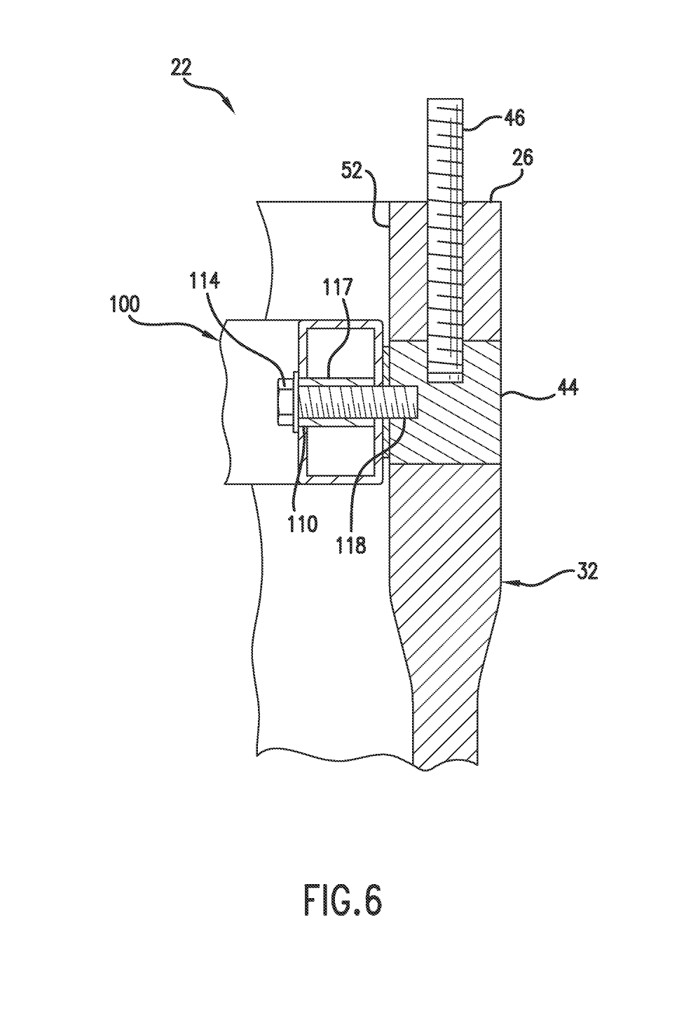

In other embodiments, the root stiffener 100 may be coupled within the root portion using any other suitable means known in the art. For example, as shown in FIG. 6, the root stiffener 100 may be coupled within the root portion 32 using the barrel nuts 44 of the root attachment assemblies 42. Specifically, a radially extending threaded opening 118 may be tapped through the side of each barrel nut 44. In such an embodiment, the radially extending stiffener openings 110 defined in the root stiffener 100 may be configured to be aligned within the threaded openings 118 defined in the barrel nuts 44. Thereafter, suitable fasteners 114 may be inserted through the stiffener openings 110 and subsequently secured within the barrel nuts 44 (e.g., by screwing the fasteners 114 into the threaded openings 118).

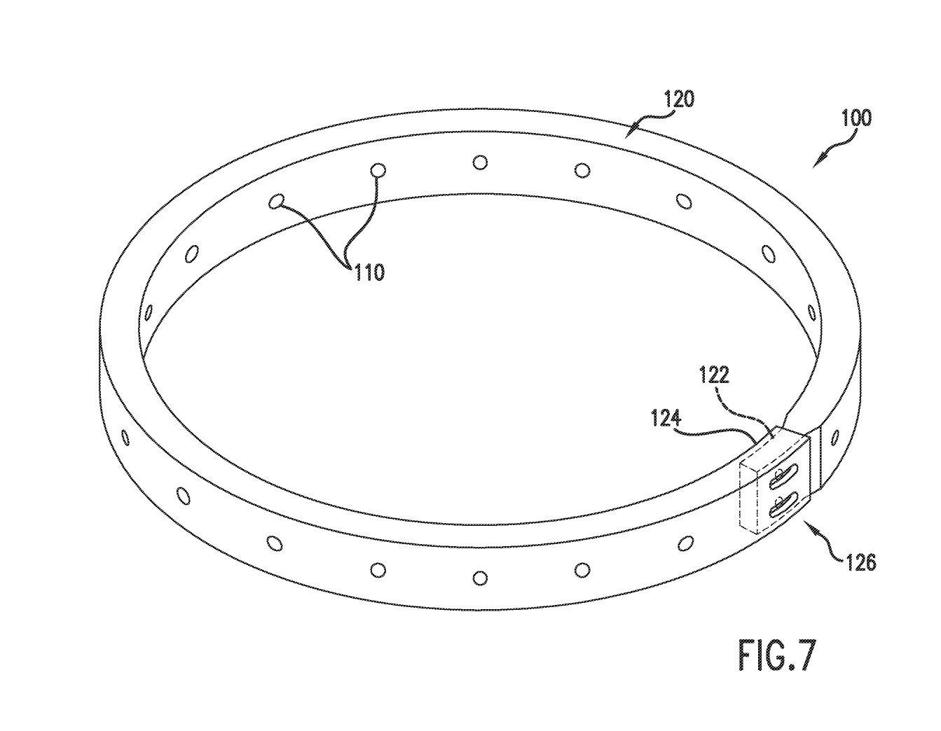

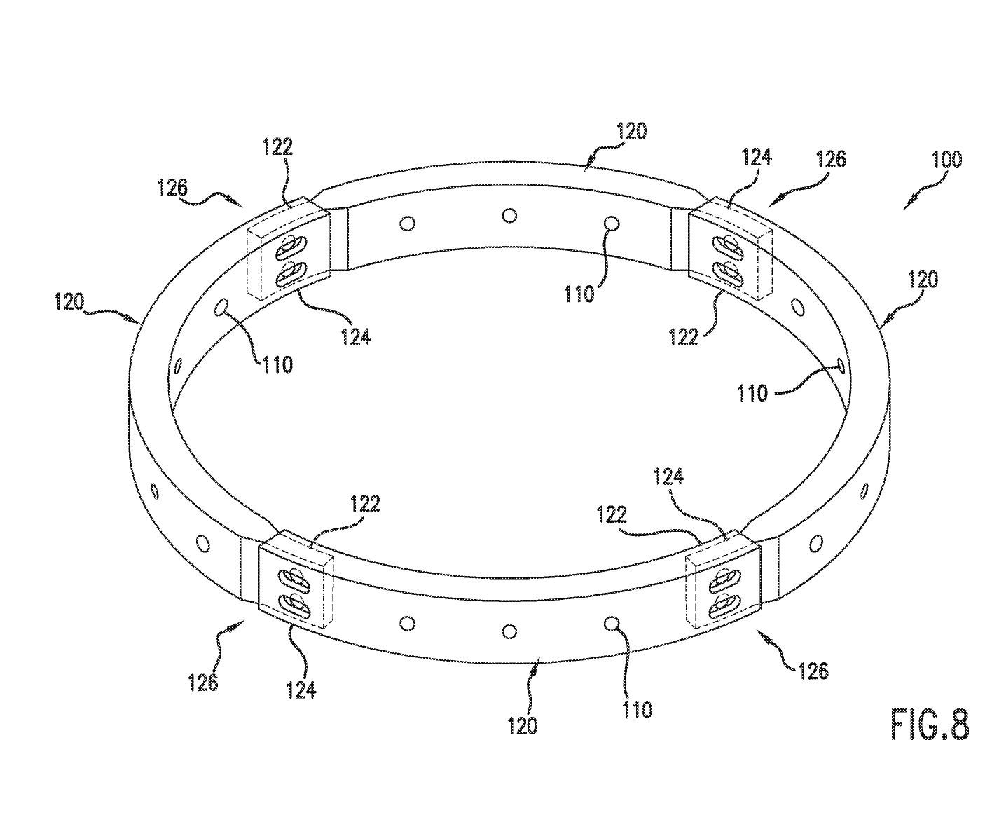

As indicated above, as an alternative to forming the root stiffener 100 as a non-jointed, continuous ring, the stiffener 100 may be formed one or more stiffener segments. For example, as shown in FIG. 7, in one embodiment, the root stiffener 100 may be formed from a single, curved or arcuate stiffener segment 120, with the opposite ends of the segment 120 being configured to be coupled together to form the ring-shaped stiffener 100. Specifically, as shown, a first end 122 of the stiffener segment 120 may be coupled to a second end 124 of the segment 120 at a suitable connection joint 126. In another embodiment, as shown in FIG. 8, the root stiffener 100 may be formed from a plurality of curved or accurate stiffener segments 120. In such an embodiment, each stiffener segment 120 may extend between a first end 122 and a second end 124, with the ends each pair of adjacent stiffener segments 120 being configured to be coupled together at a suitable connection joint 126 to from the ring-shaped stiffener 100.

One of ordinary skill in the art should be appreciate that the inner circumference of the root portion 32 (defined around its inner surface 52) may not be perfectly round. As such, it may be desirable to provide the root stiffener 100 with some radial adjustment to accommodate any local out-of-roundness in the root portion 32. As indicated above with references to FIGS. 7 and 8, the root stiffener 100 may, in several embodiments, be formed from one or more stiffener segments 120. In such embodiments, the connection joint 126 used to couple the segment(s) 120 together may be configured to provide for some radial adjustment within the root stiffener 100.

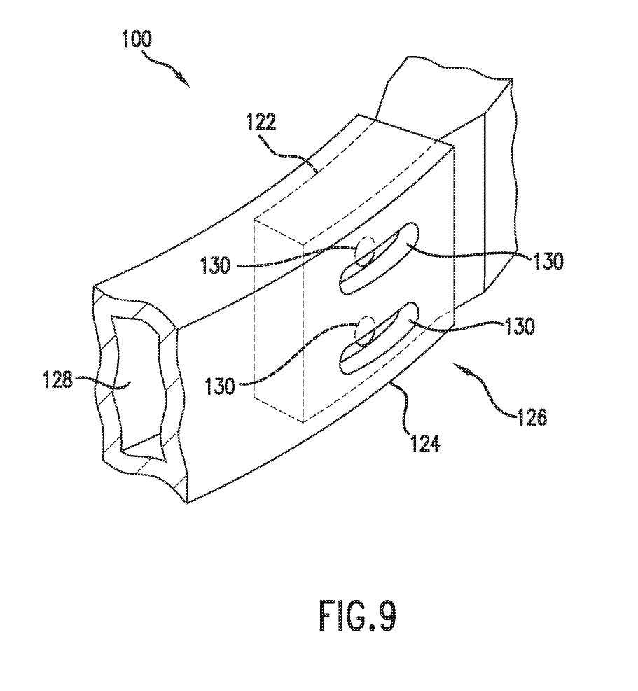

For example, FIG. 9 illustrates one embodiment of a suitable connection joint 126 that may be formed between a first end 122 and a second end 124 of the root stiffener 100, wherein the ends 122, 124 correspond to the ends of adjacent stiffener segments 120 (e.g., as in FIG. 8) or the opposite ends of the same stiffener segment 122 (e.g., as in FIG. 7). As shown in FIG. 9, the connection joint 126 may be configured as a slip-in or lap joint, with the first end 122 being configured to be received with the second end 124. Specifically, the first end 122 may be tapered or otherwise may be dimensionally smaller than an opening 128 defined at the second end 124 such that the first end 122 may be inserted into the second end 124. Additionally, as shown in FIG. 9, one or more fastener openings 130 may be defined in each end 122, 124 to allow the ends 122, 124 to be coupled together using suitable fasteners (not shown). In doing so, the fastener opening(s) 130 defined in the first end 122 and/or second end 124 may be elongated to allow for some radial adjustment of the root stiffener 100. As a result, the relative positioning of the first and second ends 122, 124 may be adjusted to allow for some adjustment in the overall diameter of the root stiffener 100.

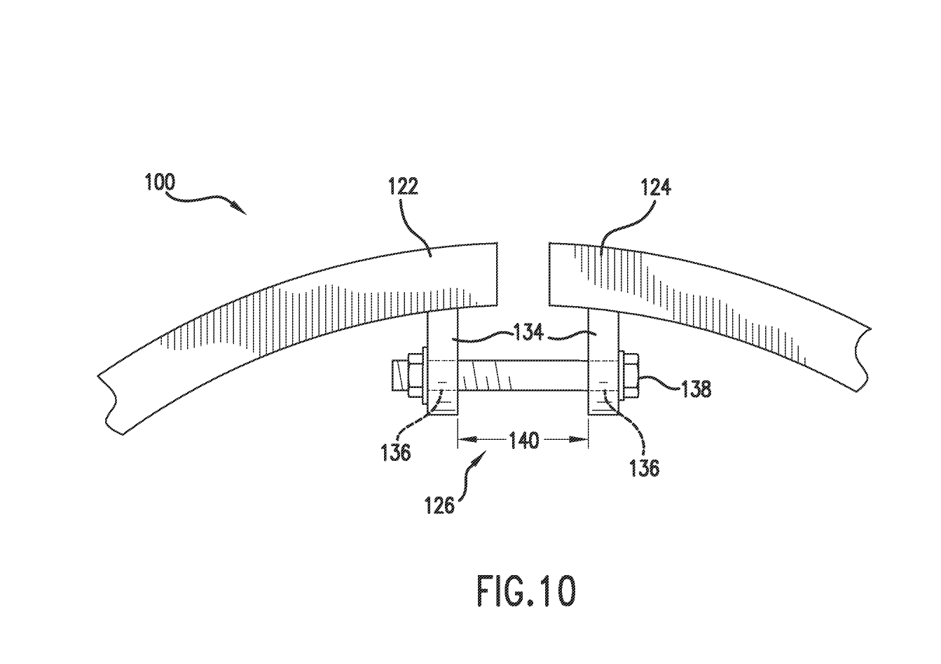

Alternatively, FIG. 10 illustrates another embodiment of a suitable connection joint 126 that may be formed between the first and second ends 122, 124. As shown, each end 122, 124 may include a flange 134 projecting from the inner circumference of the root stiffener 100. Additionally, each flange 134 may define a flange opening 136 (e.g., a threaded opening) configured to receive a suitable fastener 138. In such an embodiment, by adjusting a length 140 of the fastener 138 that extends between the flanges 134, the relative positioning of the first and second ends 122, 124 may be adjusted to allow for some radial adjustment of the root stiffener 100.

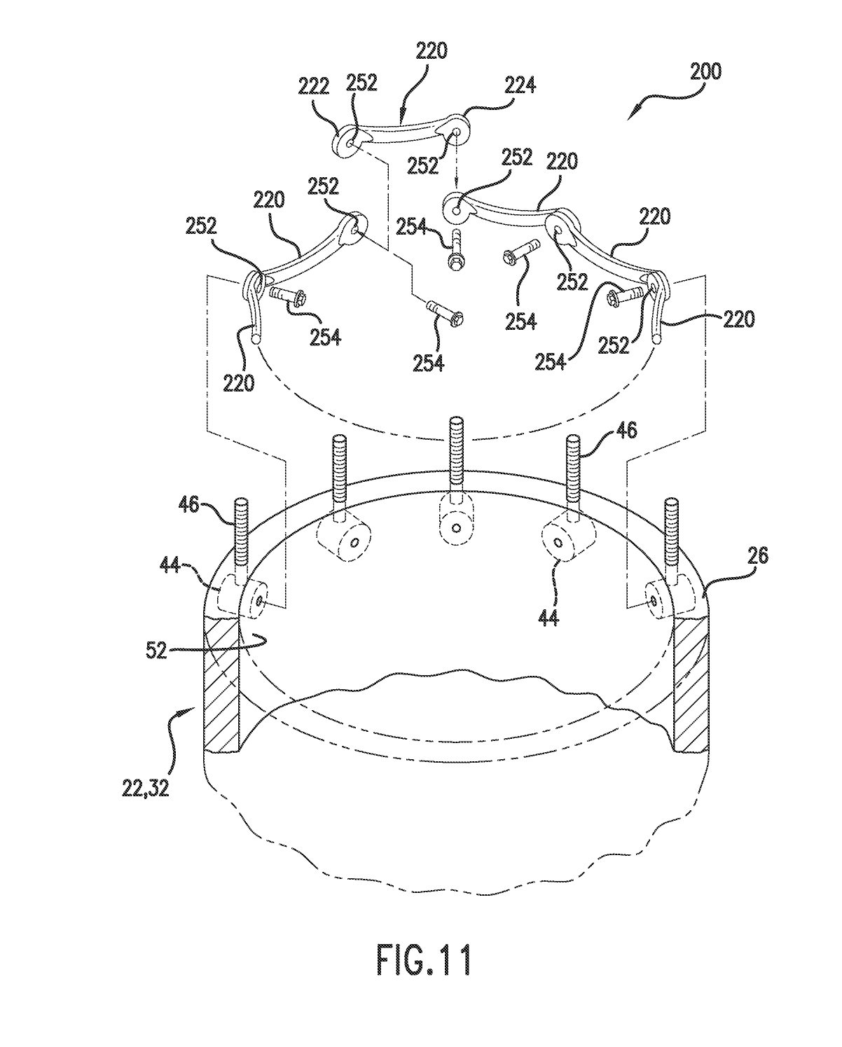

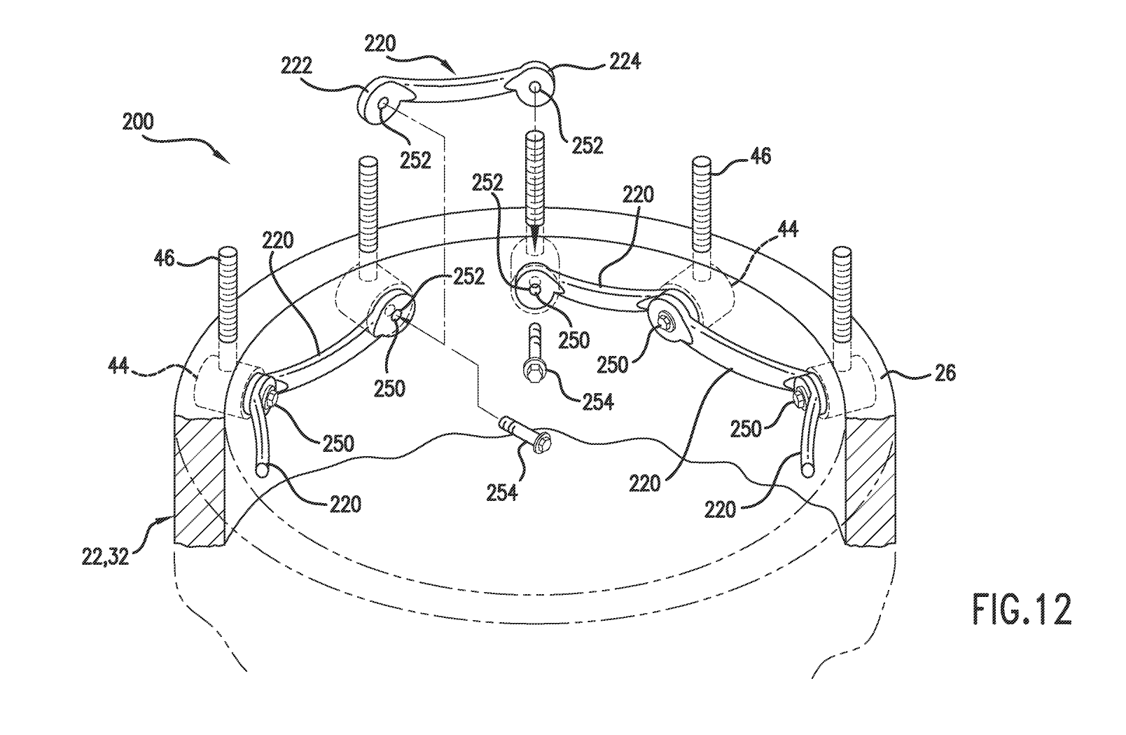

Referring now to FIGS. 11 and 12, another embodiment of a root stiffener 200 is illustrated in accordance with aspects of the present subject matter. Specifically, FIG. 11 illustrates a partial, perspective view of the root stiffener 200 exploded outwardly from the root portion 32 of a rotor blade 22 and FIG. 12 illustrates a perspective, close-up view of a portion of the root stiffener 200 installed within the rotor blade 22.

As shown, the root stiffener 200 is configured to be installed within the root portion 32 of the rotor blade 22. Similar to the root stiffener 100 shown in FIG. 8, the root stiffener 200 includes a plurality of separate stiffener segments 220 configured to coupled end-to-end around the inner circumference of the root portion 32 so as to form a ring-shaped stiffening member. However, unlike stiffener segments 120 described above, the stiffener segments 220 are coupled to one another and the root portion 32 at a common connection point 250. Specifically, as shown in FIGS. 11 and 12, each stiffener segment 220 may extend lengthwise between a first end 222 and a second end 224, with the ends 222, 224 of adjacent segments 220 being configured to overlap one another to allow such ends to be coupled to the root portion 32 at a common connection point 250. In such an embodiment, the overlapping ends 222, 224 may define aligned openings 252 at each connection comment point 250. Thus, suitable fasteners 254 may be inserted through each aligned pair of openings 242 to allow the adjacent stiffener segments 250 to be coupled to both one another and the root portion 32. For instance, as shown in the illustrated embodiment, each fastener 254 may be inserted through the openings 252 and screwed into a corresponding threaded opening (not shown) defined in one of the barrel nuts 44 (e.g., similar to the connection shown in FIG. 6). Alternatively, each fastener 254 may be inserted through both the openings 252 and a corresponding radially extending opening (not shown) defined through the root portion 32 (e.g., similar to the connection shown in FIG. 5).

Additionally, it should be appreciated that, unlike the arced or curved stiffener segments 120 described above, each stiffener segment 220 may, in several embodiments, define a relatively straight profile between its first and second ends 222, 224. For example, as shown in FIGS. 11 and 12, the stiffener segments 220 are configured as tie rods (or any other suitable elongated, relatively straight structural members). However, in other embodiments, each stiffener segments 220 may be curved or arced between its ends 222, 224.

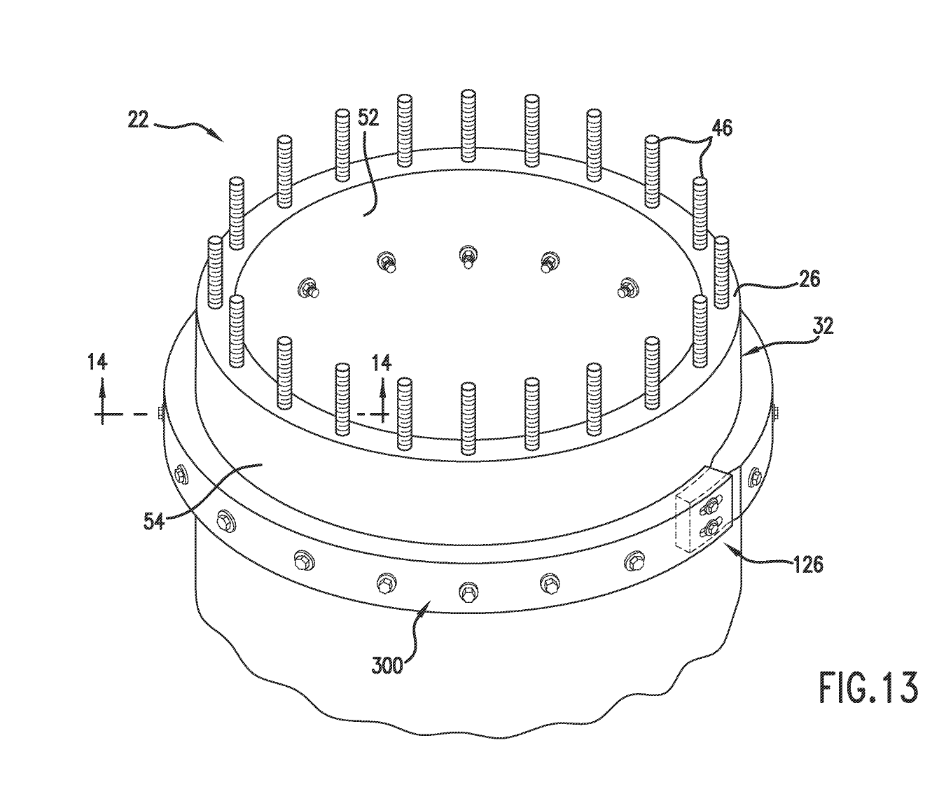

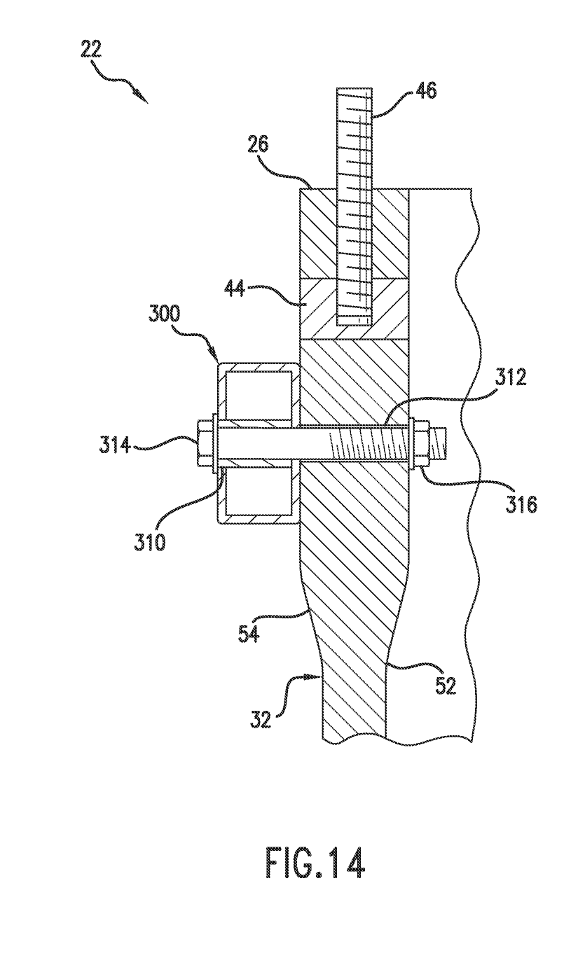

Referring now to FIGS. 13 and 14, another embodiment of a root stiffener 300 is illustrated in accordance with aspects of the present subject matter. Specifically, FIG. 13 illustrates a perspective view of the root stiffener 300 installed onto the root portion 32 of a rotor blade 22 and FIG. 14 illustrates a partial, cross-sectional view of the root stiffener 300 shown in FIG. 13 taken about line 14-14.

As shown, unlike the root stiffeners 100, 200 described above, the root stiffener 300 is configured to be installed around the outer circumference of the root portion 32 of the rotor blade 22. Specifically, the root stiffener 300 may comprise a substantially ring-shaped stiffening member that is configured to be positioned adjacent to an outer surface 54 of the root portion 32 such that the stiffener 300 extends around the outer circumference of the root portion 32. As such, when installed on the rotor blade 22, the root stiffener 300 may generally increase the overall stiffness and/or rigidity of the root portion 32, thereby preventing and/or reducing the amount of ovalization within the root portion 32.

In general, the root stiffener 300 may be configured to the same as or similar to the root stiffener 100, 200 described above. For example, the root stiffener 300 may generally be formed from any suitable material (e.g., a relatively stiff and/or rigid material) and may define a hollow or a solid cross-section. Additionally, in one embodiment, the root stiffener 300 may be formed from as a single piece, continuous ring. Alternatively, the root stiffener 300 may be formed from a plurality of stiffener segments (e.g., two or more ring segments) or as a single stiffener segment with ends configured to be coupled together to form the ring-shaped stiffener 300. In such an embodiment, a suitable connection joint (e.g., the connection joint 126 shown in FIG. 9 or FIG. 10) may be used to couple the stiffener segment(s) together to provide for some radial adjustment within the root stiffener 300, thereby allowing the stiffener 300 to accommodate variations in the outer diameter of the root portion 32.

Moreover, it should be appreciated that the root stiffener 300 may be configured to be coupled around the outer circumference of the root portion 32 using any suitable means known in the art. For example, as shown in FIG. 14, similar to the embodiment described above with reference to FIG. 5, the root stiffener 300 may define a plurality of radially oriented stiffener openings 310 configured to be aligned with corresponding, radially oriented root openings 312 defined in the root portion 312. Suitable radially extending fasteners 314 then be inserted through the aligned openings 310, 312 and subsequently secured therein using nuts 316 (and, optionally, washers) and/or any other suitable components. Alternatively, similar to the embodiment described above with reference to FIG. 6, the root stiffener 300 may be coupled to the root portion 32 using fasteners extending through the root stiffener 300 and into radially extending, threaded openings defined in the barrel nuts 44.

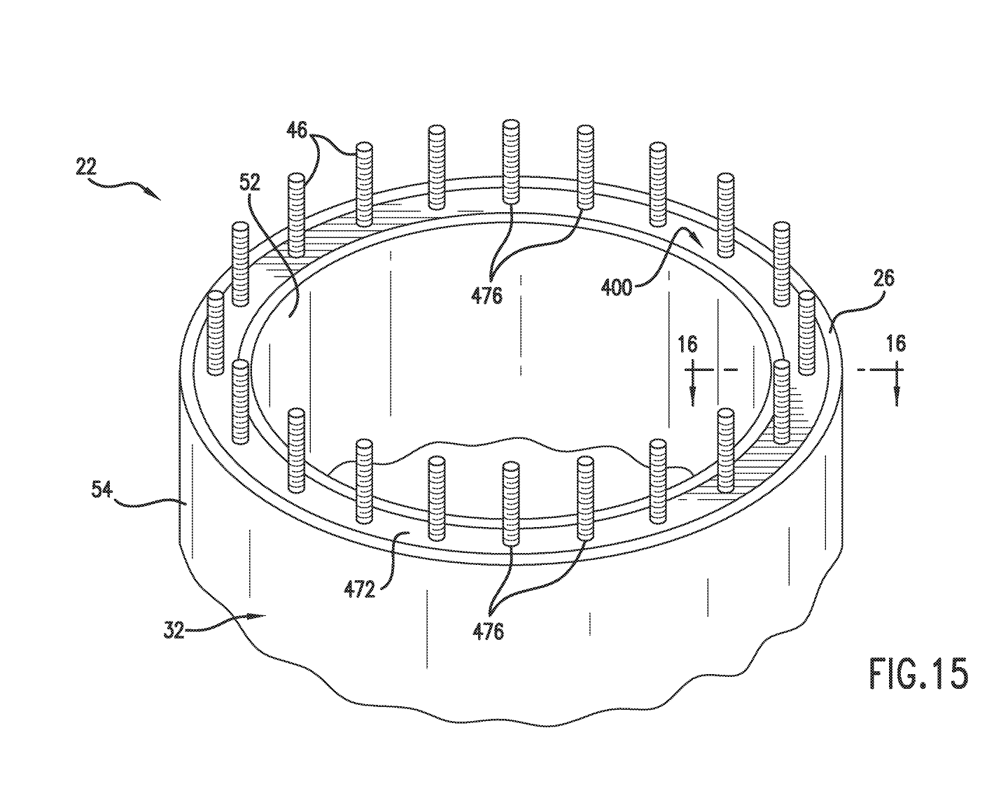

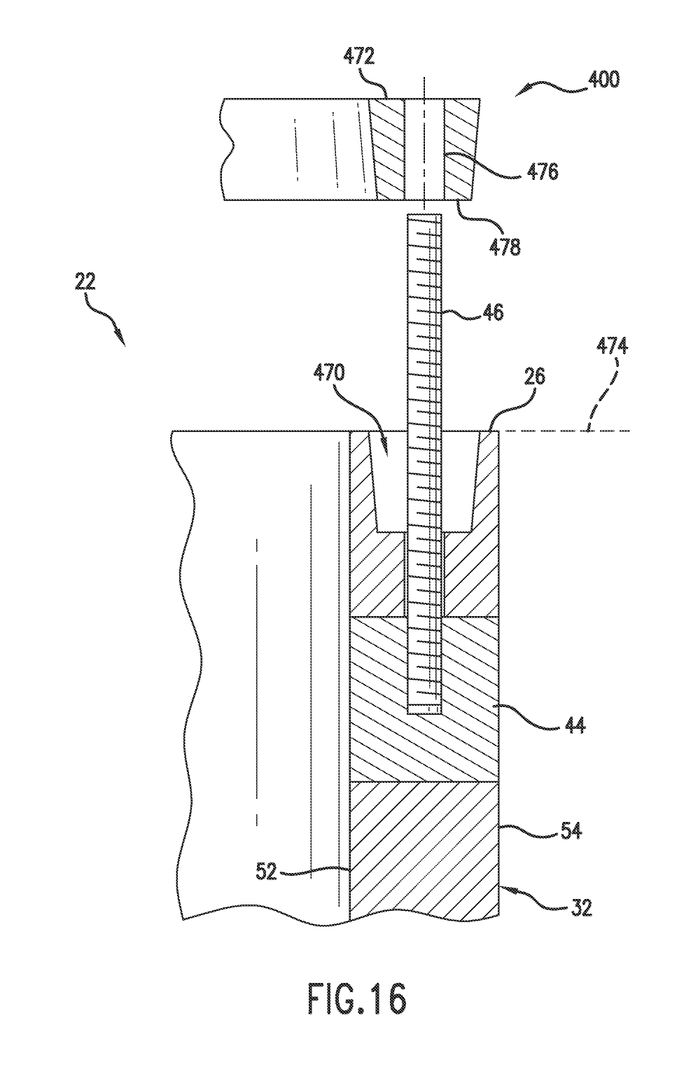

Referring now to FIGS. 15 and 16, another embodiment of a root stiffener 400 is illustrated in accordance with aspects of the present subject matter. Specifically, FIG. 15 illustrates a perspective view of the root stiffener 500 installed within the root portion 32 of a rotor blade 22 and FIG. 16 illustrates a cross-sectional view of the root portion shown in FIG. 15 taken about line 16-16, with the root stiffener 500 being exploded away from the root portion 32.

As shown, instead of being coupled around the inner circumference or outer circumference of the root portion 32, the root stiffener 400 may be a ring-shaped stiffening member configured to be embedded within the root portion 32. Specifically, in several embodiments, a ring-shaped channel or trench 470 (FIG. 16) may be formed in the root end 26 of the rotor blade 22 that is configured to receive the ring-shaped root stiffener 400. In such embodiments, the root stiffener 400 may be inserted within the trench 470 such that a top surface 472 of the root stiffener 400 is disposed either coplanar with a reference plane 474 defined by the root end 26 of the rotor blade 22 or outboard of such reference plane 474 (i.e., closer to the blade tip 28 than the reference plane 474). Additionally, the root stiffener 400 may define a plurality of openings 476 configured to receive the root bolts 46 of the root attachment assemblies 42. For example, as shown in FIG. 16, each root bolt 46 may be configured to be received within one of the openings 476 defined in the root stiffener 400 when the root stiffener 400 is installed within the root portion 32.

It should be appreciated that the trench 470 and the stiffener 400 may each have any suitable shape that allows the stiffener 400 to be inserted within the trench 470. For example, in several embodiments, the trench 470 and the stiffener 400 may define corresponding tapered profiles. Specifically, as shown in FIG. 16, the trench 470 may be tapered such that its cross-sectional width steadily decreases from the root end 26 of the rotor blade 22. Similarly, the stiffener 400 may be tapered such that its cross-sectional width steadily decreases from its top surface 472 to its bottom surface 478. Thus, when the root stiffener 400 is inserted within the trench 470, the side surfaces of the stiffener 400 may be seated flush against and in contact with the corresponding side surfaces of the trench 470. However, in other embodiments, the trench 470 and the stiffener 400 may each define any other suitable shape, including mismatched or non-complimentary shapes.

It should also be appreciated that the root stiffener 400 may be configured to be secured within the trench 470 using any suitable means known in the art. For example, in one embodiment, the root stiffener 400 may be secured within the trench 470 using a suitable adhesive(s). In another embodiment, suitable fasteners may be may be utilized to secure the root stiffener 400 within the trench 470. In such an embodiment, the fasteners may be separate fasteners specifically designed to secure the root stiffener 400 within the trench 470 or the fasteners may be the root bolts 46. For instance, the openings 476 defined in the root stiffener 400 may be threaded such that the root bolts 46 may be screwed into both the root stiffener 400 and the barrel nuts 44. In a further embodiment, the root stiffener 400 may be simply be configured to be trapped within the trench 470. Specifically, the root stiffener 400 may be trapped between the rotor blade 22 and its corresponding pitch bearing (not shown) when the when the blade 22 is installed onto the wind turbine hub 20 (FIG. 1).

Additionally, in several embodiments, the root stiffener 400 may be formed from a relatively stiff and rigid material. For instance, suitable rigid materials may include metal materials (e.g., steel), laminate composite materials (e.g., a carbon or glass fiber reinforced composite), or any other suitable stiff/rigid materials.

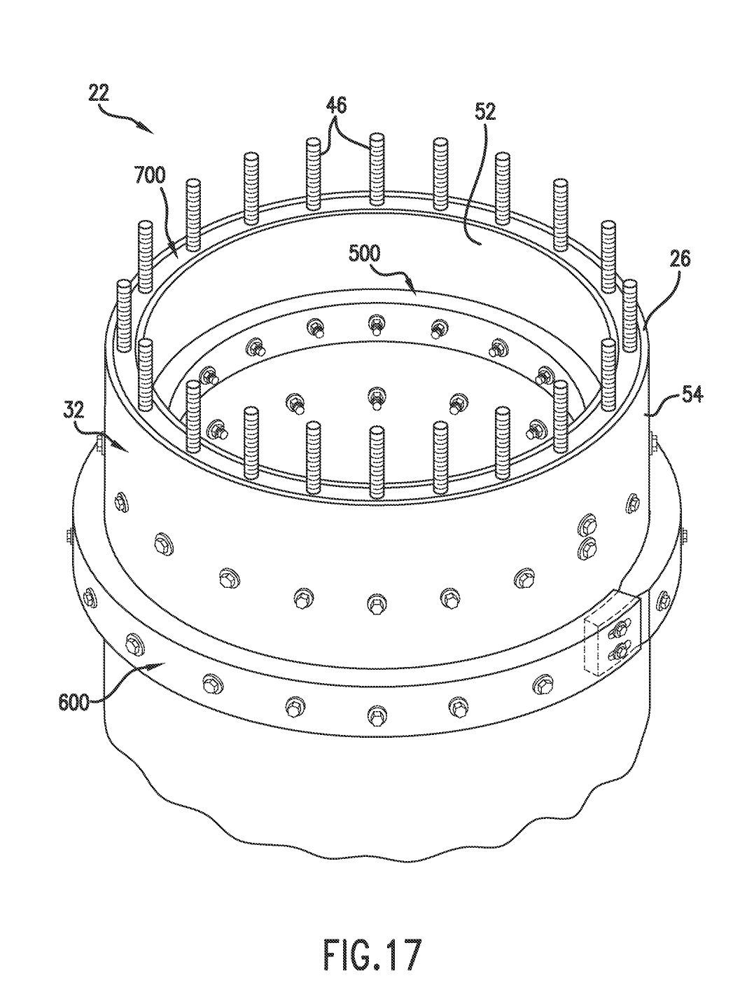

It should be appreciated that although the rotor blades 22 have been described herein as having a single root stiffener, each rotor blade 22 may generally include any number of root stiffeners, including different types of root stiffeners. For example, FIG. 17 illustrates a perspective view of a rotor blade 22 having multiple root stiffeners 500, 600, 700. Specifically, as shown, the rotor blade 22 includes a substantially ring-shaped, first root stiffener 500 coupled to and extending around the inner circumference of the root portion 32 (e.g., one of the root stiffeners 100, 200 described above with reference to FIGS. 3-12). Additionally, the rotor blade 22 includes a substantially ring-shaped, second root stiffener 600 coupled to and extending around the outer circumference of the root portion 32 (e.g., the root stiffener 300 described above with reference to FIGS. 13 and 14). Moreover, the rotor blade 22 includes a substantially ring-shaped, third root stiffener 700 embedded within the root portion 32 at the root end 26 of the rotor blade 22 (e.g., the root stiffener 400 described above with reference to FIGS. 15 and 16). It should be appreciated that, in alternative embodiments, the rotor blade 22 may include any other suitable combination of the root stiffeners disclosed herein, such as by including a combination of the first and second root stiffeners 500, 600, the first and third root stiffeners 500, 600 or the second and third root stiffeners 600, 700.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade for a wind turbine, the rotor blade comprising:
a body extending between a root end and a tip end, the body including a root portion extending from the root end, the root portion including an inner surface defining an inner circumference; and
a root stiffener disposed within the root portion of the body, the root stiffener being substantially ring-shaped and extending around the inner circumference of the root portion, the root stiffener defining a plurality of radially oriented openings configured to receive fasteners for coupling the root stiffener to the root portion.

2. The rotor blade of claim 1, wherein the root portion defines a plurality of radially oriented openings configured to be aligned with the radially oriented openings defined in the root stiffener.

3. The rotor blade of claim 1, further comprising a plurality of barrel nuts mounted within the root portion, each barrel nut defining a radially oriented opening configured to be aligned with the radially oriented openings defined in the root stiffener.

4. The rotor blade of claim 1, wherein the root stiffener defines a hollow cross-section.

5. The rotor blade of claim 1, wherein the root stiffener is formed from at least one stiffener segment.

6. The rotor blade of claim 5, wherein ends of the at least one stiffener segment are coupled together using a connection joint that provides for radial adjustment of the root stiffener within the root portion.

7. The rotor blade of claim 1, wherein the root stiffener is formed from a plurality of stiffener segments, the plurality of stiffener segments being coupled end-to-end at common connection points around the inner circumference of the root portion.

8. The rotor blade of claim 1, further comprising at least one cross-brace extending across an opening defined by the root stiffener.

9. The rotor blade of claim 1, wherein the root stiffener comprises a first root stiffener, further comprising a second root stiffener coupled around an outer circumference of the root portion.

10. The rotor blade of claim 1, wherein the root stiffener comprises a first root stiffener and wherein a trench is defined in the root portion at the root end, further comprising a second root stiffener received within the trench.

11. A rotor blade for a wind turbine, the rotor blade comprising:
a body extending between a root end and a tip end, the body including a root portion extending from the root end, the root portion including an outer surface defining an outer circumference; and
a root stiffener coupled to the root portion, the root stiffener extending at least partially around the outer circumference of the root portion.

12. The rotor blade of claim 11, wherein the root stiffener is substantially ring-shaped, the root stiffener extending around the entire outer circumference of the root portion.

13. The rotor blade of claim 11, wherein the root stiffener defines a plurality of radially oriented openings configured to receive fasteners for coupling the root stiffener to the root portion, the root portion defining a plurality of radially oriented openings configured to be aligned with the radially oriented openings defined in the root stiffener.

14. The rotor blade of claim 11, further comprising a plurality of barrel nuts mounted within the root portion, wherein the root stiffener defines a plurality of radially oriented openings configured to receive fasteners for coupling the root stiffener to the root portion, each barrel nut defining a radially oriented opening configured to be aligned with the radially oriented openings defined in the root stiffener.

15. The rotor blade of claim 11, wherein the root stiffener is formed from at least one stiffener segment.

16. The rotor blade of claim 15, wherein ends of the at least one stiffener segment are coupled together using a connection joint that provides for radial adjustment of the root stiffener.

17. A rotor blade for a wind turbine, the rotor blade comprising:
a body extending between a root end and a tip end, the body including a root portion extending from the root end, the root portion defining a ring-shaped trench at the root end; and
a rigid root stiffener received within the trench, the root stiffener being substantially ring-shaped.

18. The rotor blade of claim 17, wherein a top surface of the root stiffener is configured to be positioned either coplanar with a reference plane defined by the root end or outboard of the reference plane.

19. The rotor blade of claim 17, further comprising a plurality of barrel nuts coupled within the root portion, the root stiffener defining a plurality of openings configured to receive root bolts, the root bolts being configured to be coupled to the barrel nuts.

20. The rotor blade of claim 15, wherein the root stiffener and the trench define corresponding tapered cross-sectional profiles.
